(19) United States
(12) Patent Application Publication
(10) Pub. No.: US 2026/0147875 A1
(43) Pub. Date: May 28, 2026

(54) Application Deployment Assistant

(71) Applicant: TEACHERS INSURANCE AND ANNUITY ASSOCIATION OF AMERICA, New York, NY (US)

(72) Inventors: Danielle Marie Binder, Garnet Valley, PA (US); Christopher Charles Boyce, Huntersville, NC (US); Timothy Kenneth Lee, East Bethany, NY (US); Anthony Michael Lombardino, Point Pleasant, NJ (US); Danesha Yvette Williams, Charlotte, NC (US)

(21) Appl. No.: 18/959,348

(22) Filed: Nov. 25, 2024

(51) Int. Cl. G06F 21/52

(52) U.S. Cl. CPC G06F 21/52

(57) ABSTRACT

Techniques for validating a software application are disclosed herein. An example computer-implemented method includes receiving, by one or more processors, data input from a user that corresponds to a software application; storing, by the one or more processors, the software application in a management system; performing, by the one or more processors, validation of the software application that the software application meets a criteria. Validation includes analyzing the software application for potential deployment problems, where at least one of the validation criteria is whether the software application is related to an authorized user or group. As a result of the validation, either deploying, by the one or more processors, the software application for use outside of the authorized user or group or restricting software application use to the authorized user or group until the validation process is completed.

### TECHNICAL FIELD

The present disclosure generally relates to developing and deploying applications, and more particularly, to techniques for facilitating deployment that avoid deployment problems.

### BACKGROUND

Developing and deploying a custom application can be a difficult process with many opportunities for problems to arise, especially if the application developers are not seasoned experts. For example, in a large corporation, a software application that does not function properly can have knock-on effects that can impact the operations of various business teams, resulting in lost productivity. As such, many corporations restrict software application development to a specified development group, which can increase the time it takes an application to be developed and lead to reduced innovation.

Software application development and deployment have been greatly aided by development of low coding development environments that enable people without coding or information technology training to develop software applications. Low-code environments allow both users with technical and non-technical backgrounds to quickly develop solutions that solve business problems that are unique to a user or group. Further, users can analyze data, automate business processes, and build apps, websites, and virtual agents.

However, building and deploying these software applications can be problematic if they are not properly governed and maintained. Conventional software application deployment techniques suffer from several notable drawbacks, such as not having a standardized, repeatable method for validating software applications prior to deploying them to wider use. For example, a software application can be developed by a single person and deployed to an organization. This can lead to problems if that single person stops maintaining the application or leaves the organization. The organization can suddenly lose the functionality of the software application without warning or a plan for replacing the software application. Further, software applications can be built in independent, unmonitored environments that leave increased room for error. The conventional process for deploying applications is unclear, complicated, and can be dependent on a small number of developers, which can create problems with developer availability and be very time consuming.

Therefore, conventional software application deployment methods can provide insufficient safeguards to prevent a software application from becoming a risk to an organization. Poorly developed applications can result in several negative consequences, such as lost productivity, network downtime, or lost data. Accordingly, a need exists for a method and system for deploying software applications that prevents broken or poorly functioning software applications from being deployed for wider use by a user group and allows more novice software application developers to accurately and safely deploy software applications for wider use.

### SUMMARY

In some aspects, a computer-implemented method for validating a software application includes receiving, by one or more processors, data input from a user that corresponds to a software application, storing, by the one or more processors, the software application in a management system, and performing, by the one or more processors, validation of the software application that the software application meets a criteria, wherein validation includes analyzing the software application for potential deployment problems; wherein at least one of the validation criteria may be whether the software application is related to an authorized user or group. The computer implemented method may further include, as a result of the validation, either deploying, by the one or more processors, the software application for use outside of the authorized user or group or restricting software application use to the authorized user or group until the validation process is completed.

Furthermore, in some aspects, a computing system for deploying an application comprises one or more processors. The computing system also comprises a non-transitory computer-readable medium that may be coupled to the one or more processors and a communication unit and storing instructions. When the instructions are executed by the one or more processors, the instructions cause the computing device to receive data input from a user that corresponds to a software application, store the application in a management system, and perform validation of the software application that the software application meets a criteria. The validation involves analyzing the software application for potential deployment problems, wherein at least one of the validation criteria may be whether the software application is related to an authorized user or group. As a result of the validation, the one or more processors may either deploy the software application for use outside of the authorized user or group or restrict software application use to the authorized user or group until the validation process is completed.

Moreover, in some aspects, one or more non-transitory computer-readable storage media include instructions for validating a software application that, when executed by one or more processors of a computing device, cause the computing device to receive data input from a user in the form of code that corresponds to a software application, store the software application in a management system, and perform validation of the software application that the software application meets a criteria, wherein validation involves analyzing the software application for potential deployment problems, wherein at least one of the validation criteria may be whether the software application is related to an authorized user or group. The instructions, when executed by the one or more processors, further cause the one or more processors, as a result of the validation, to either deploy the software application for use outside of the authorized user or group or restrict the software application use to the authorized user or group until the validation process is completed.

Broadly speaking, the software application validation and deployment techniques provided herein may streamline the software application and deployment process, making the process more straightforward for those without a rigorous technical background and reducing the number of software applications that are deployed that are unfinished or contain problems that may cause problems in an organization. More specifically, the techniques of the present disclosure may analyze user-provided software applications to detect potential deployment problems, using specified criteria to validate software applications, where the criteria are determined to prevent the most common deployment problems. The techniques of the present disclosure may improve over conventional software application deployment and validation techniques at least by generating more functional and usable software applications than such conventional techniques. In addition, the techniques of the present disclosure may then result in reduced network downtime, increased worker productivity, and improved network security by deploying software applications that have less vulnerabilities.

In some examples, the techniques of the present disclosure may be implemented in any size organization and not expensive or difficult to implement. By introducing tools to support application lifecycle management, standard processes may be established between development, test, and operations teams to improve efficiency and introduce repeatable patterns for software application delivery. These elements may provide improvements over conventional techniques for multiple reasons.

The disclosed method may provide for a streamlined deployment process that does not depend on any single developer. Because low-coding environments allows for software application development by non-technical and technical users, the present method and system may be straightforward and easy to use. As one example, by clearly defining the criteria for validation before deployment, the disclosed method and system may improve on conventional deployment processes that can be opaque to inexperienced users.

As another example, the feature generation algorithm and machine learning model configuration of the present techniques may provide a general-purpose solution to the software application validation problem. Unlike conventional techniques, the algorithms/models of the present techniques may be capable of efficiently analyzing and validating software applications. The present techniques therefore may be capable of identifying and solving possible deployment problems associated with software applications, thereby greatly reducing the number of issues and problems encountered in the software application deployment process and once the software application has been deployed.

The techniques of the present disclosure may thus improve the functionality of a computing device at least by deploying software applications that are fully functional and able to easily be supported by the computing device. The validation method, executing on the management system, may analyze received software application data and may analyze the data for potential deployment problems. That is, the present disclosure describes improvements in the functioning of the computer itself because the computing device may more accurately validate software applications as a direct result of the present method. This improves over the prior art at least because existing systems typically do not rigorously analyze software applications for specific validation criteria and are not able to deploy software applications that will operate with a low number of problems and incidents.

Moreover, the present disclosure may include effecting a transformation or reduction of a particular article to a different state or thing, e.g., transforming or reducing problems and incidents of a software applications running on a computing system (and associated subsystems/components/devices) from a non-optimal or error state (e.g., highly problematic) to an optimal (or closer to optimal) state by validating software applications prior to deployment, and consequently substantially reducing further problems for software applications.

Still further, the present disclosure includes specific features other than what is well-understood, routine, conventional activity in the field, or adds unconventional steps that demonstrate, in various embodiments, particular useful software applications, e.g., performing validation of the software application that the software application meets a criteria, wherein validation includes analyzing the software application for potential deployment problems; wherein at least one of the validation criteria is whether the software application is related to an authorized user or group, among others.

Of course, it should be appreciated that the advantages and technical improvements described above and elsewhere herein are not the only advantages and/or technical improvements that may be realized as a result of the techniques described herein. Other advantages and/or technical improvements to the functioning of a computer itself or other technologies or technical fields may be apparent to one of ordinary skill in the art. Moreover, while described herein primarily in the software application development context, the techniques described herein may be readily applied in any suitable field for any suitable purpose.

### BRIEF DESCRIPTION OF THE DRAWINGS

The Figures described below depict preferred embodiments for purposes of illustration only. One skilled in the art will readily recognize from the following discussion that alternative embodiments of the systems and methods illustrated herein may be employed without departing from the principles of the disclosure described herein.

FIG. 1 depicts an example computing system in which various embodiments of the present disclosure may be implemented.

FIGS. 2, 3, and 4 depict example message screens that may be displayed during the deployment validation process, in accordance with various embodiments described herein.

FIGS. 5, 6A, and 6B depict example process flows, in accordance with various embodiments described herein.

### DETAILED DESCRIPTION

Techniques of the present disclosure enable software applications to be validated before they are widely deployed to an organization or wider audience. By integrating the deployment assistant provided herein into a larger development workflow, standard processes may be established between development, test, and operations team to improve efficiency and introduce repeatable patterns for software delivery. The techniques provided herein are particularly relevant when there is an expanding developer footprint, resulting in a larger number of software applications being developed and possibly deployed without proper oversight.

In a large organization, it is important that all proposed software applications are validated to meet specified criteria. For instance, the validation criteria may be any required criteria as set by an organization. Possible criteria may include whether the software application is stored in a proper management system for tracking and oversight. Another criteria may include whether a user group of the software application is specified, whether the software application has a devoted development group, or whether a software application is associated with a valid service account. For instance, a service account may be considered valid if the service account is associated with appropriate permissions, licenses, and the like. Another validation criteria may be whether software application is properly named to meet any naming requirements of the organization. For instance, in some examples, the software application being properly named may mean that the name of the software application must indicate the function or purpose of the software application. Of course, other validation criteria may be developed or required by an organization.

In one example, using the techniques provided herein, a software application may be deployed for wider use outside of a developer group only if the software application meets the criteria and is validated. Software application deployment may include allowing a software application to be downloaded to a computer, placing it in a repository that may be accessed through a network by other devices, or used in an unrestricted manner within an organization. For example, using the techniques provided herein, once a software application has been fully deployed, it may be stored in a central server or application management system such as a management system that may be accessed by other users in an organization. Depending on how the application is designed and its function, it may be downloaded to a personal device or accessed through a network for use by the organization. If the software application does not meet the criteria and thus is not validated, its availability may be restricted to only the user or group that developed the software application until the validation process has been completed.

If a software application is restricted, the restrictions may comprise restricting it to a smaller user group, such as the group that is responsible for its development, which may be smaller than the wider potential user group (e.g., the entire organization) that may be available if the software application is deployed. Restricting the software application may further involve allowing it to run only in a designated operating environment, such as one that is actively monitored or devoted to software application development. Advantageously, such a designated operating environment would not have access to the wider organization network, preventing a poorly developed application from causing trouble in the organization's network.

As part of the validation process, the software application may be stored in a management system. This allows the application to be supported and tracked effectively and prevents the application from malfunctioning if an employee leaves a company, for example.

During the validation process, when a validation criteria is determined to be not met, a prompt may be displayed on a user interface that indicates the specific criteria that needs to be met or the validation steps that need to be performed for the validation process to be completed.

As part of the validation process, the deployment of the software application may be scheduled or canceled in response to a request by a user. Software application deployment may be scheduled for a specific day of the week or part of the year so that any team that oversees software applications may be prepared to monitor its performance and use when it is deployed. For example, software applications may only be allowed to be deployed in the early part of the week so that any issues may be detected and corrected quickly. Similarly, a software application deployment may be canceled in response to a request by a user, e.g., if the developer wants to make changes to the software application or determines that it is not ready for deployment.

In some examples, the techniques provided by the present disclosure may include preventing unauthorized users or groups from deploying a software application. For instance, preventing unauthorized users or groups from deploying a software application may prevent the deployment of a software application that is not validated, and may ensure that an organization is aware of all software applications that are currently being developed. In addition, the techniques provided by the present disclosure may generate a list of software applications that a particular software application developer has developed or is in the process of developing. Generating this list may allow a developer to also track their software applications through the validation process and properly maintain and track deployed software applications.

In some examples, the techniques provided by the present disclosure may display or present a pre-deployment version of the software application to certain users, so that these users may determine whether the pre-deployment version of the software is fully functional or whether there are issues to be worked out. For instance, the techniques provided by the present disclosure may run the pre-deployment version of the software in a pre-deployment environment where any problems or issues may be safely viewed on a user interface display and resolved without causing any further problems to the greater organization.

Furthermore, in some examples, the techniques provided by the present disclosure may include generating alerts based on potential deployment problems detected during the validation process. The alert may indicate that a potential deployment problem has been identified and may present options that may remove the potential problem. For example, in some examples, the techniques provided by the present disclosure may include displaying an alert indicating that a software application is not properly named. For instance, the alert may identify an incorrect name or a lack of a name and may include a recommendation that the developer rename the software application. In some examples, the alert may display the required naming convention for software applications. Additionally, in some examples, the alert may include contact information for help and/or support, or may include a direct link to communicate with another person for help or support. These alerts may facilitate correcting potential problems prior to deploying a software application and make the developing process proceed smoother with better outcomes.

The management system may include a database that stores software applications along with information related to those software applications. For example, the database of the management system may store information such as software application ownership, usage statistics for software applications, data sources that are used by the software applications, and applications that have been deployed or are in the process of deployment. Using a central management system has the advantage of storing the software applications and their associated information in a database that may be actively managed and protected from data loss or other adverse scenarios. For example, if a software application is stored solely on a personal computer or other device associated with a developer, the software application is susceptible to being lost if that device becomes unusable. A central database offers the advantages that it can be actively maintained by a broad management team, built in a distributed manner with multiple redundancies and backups, and is less susceptible to user mistakes, such as downloading viruses.

A user management system may also be implemented as an application the management system uses to track users and their associated software applications. In some examples, the user management system may require users to register before any software applications developed by those users may be validated or deployed, e.g., to ensure that users and their activity are tracked as part of software application development and/or use.

The present software application validation method may utilize machine learning algorithms to analyze software applications for potential deployment problems based on user-generated, system-generated information, or a combination of the two. The training data for the machine learning algorithm may include data that is indicative of past user-generated and system-generated information that is associated with past software applications. This past data may include indications of any deployment problems that are associated with the past software applications. The machine learning model may be used to either validate or not validate a developer's proposed software application. For example, the machine learning model may analyze a new software application compared to its learning or training about what characteristics or factors of past software applications were associated with deployment problems. The machine learning model may then identify whether the new software application is likely to have deployment problems. In addition, the results of the machine learning algorithm analysis may then be outputted to a display, including a list of potential deployment problems.

Further, the machine learning algorithm may identify options or alternatives to remove the potential deployment problem based on the training data of past software applications and associated deployment problems. The identified options or alternatives for removing potential deployment problems may be applied by a validation application. This may streamline the validation process and allow the user to focus on developing the software application in the manner that is most beneficial and works best for the user. For example, if the machine learning algorithm identifies that a software application potentially faces a problem associated with the lack of an identified service group, it may tentatively assign a group based on the characteristics of the past data, other software applications uploaded by the user, or by examining the content of the software application. As another example, if the proposed software application is related to an accounting procedure, but the user has not assigned a service group, the machine learning algorithm may examine the software application and automatically assign the accounting group as a service group.

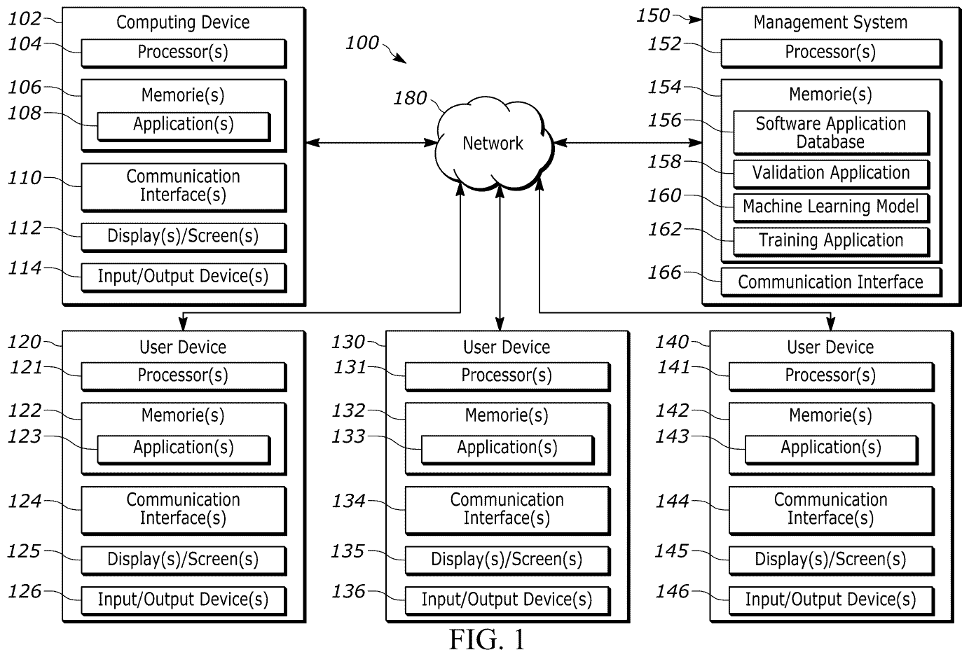

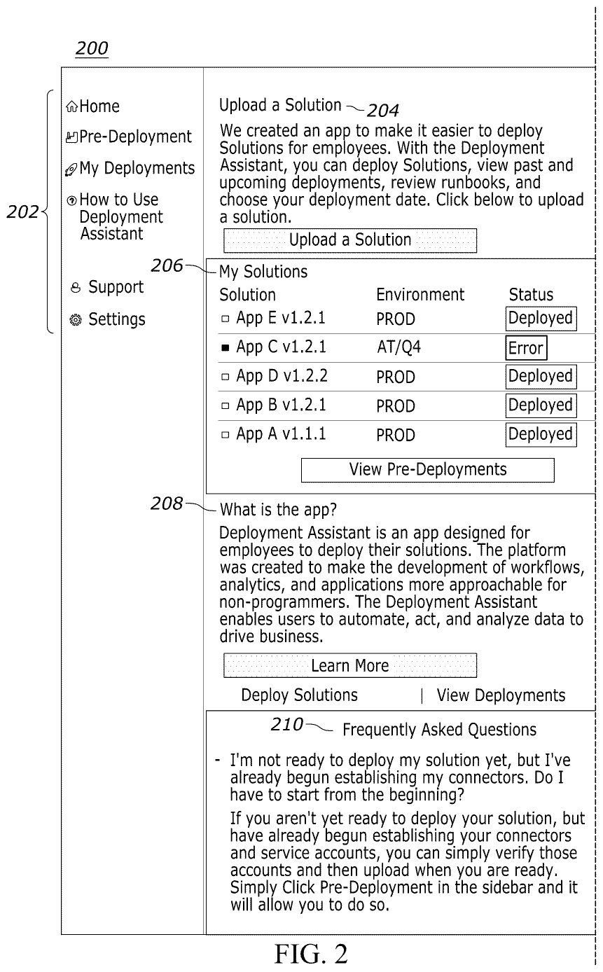

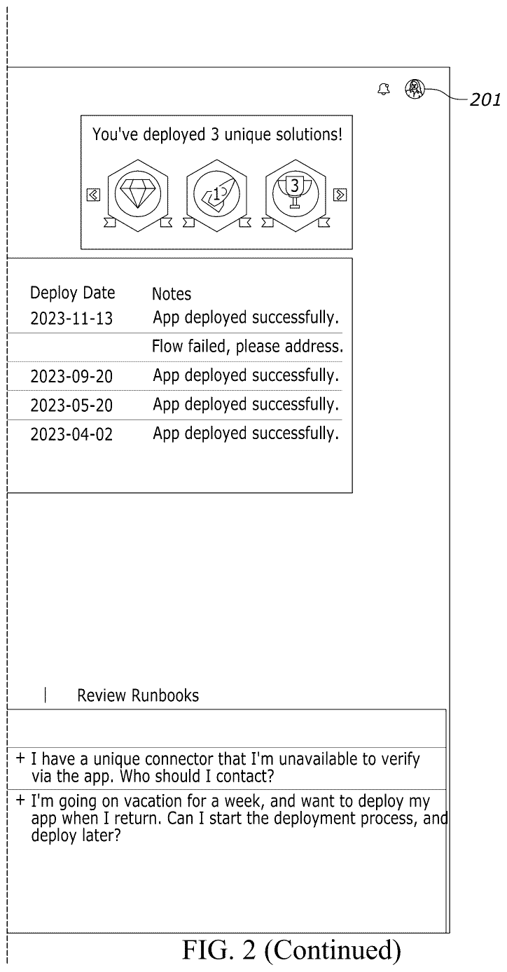

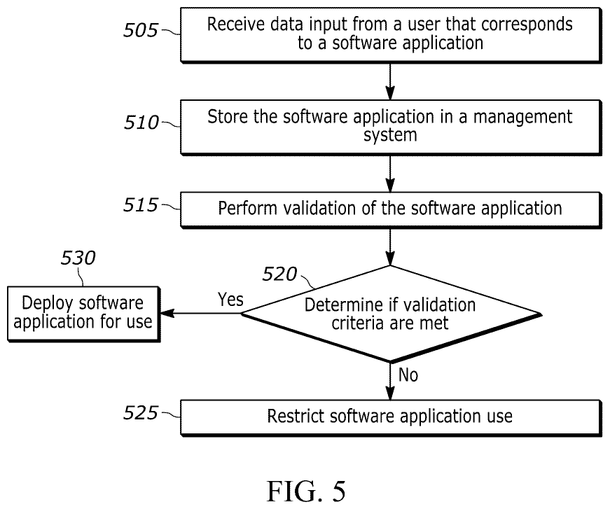

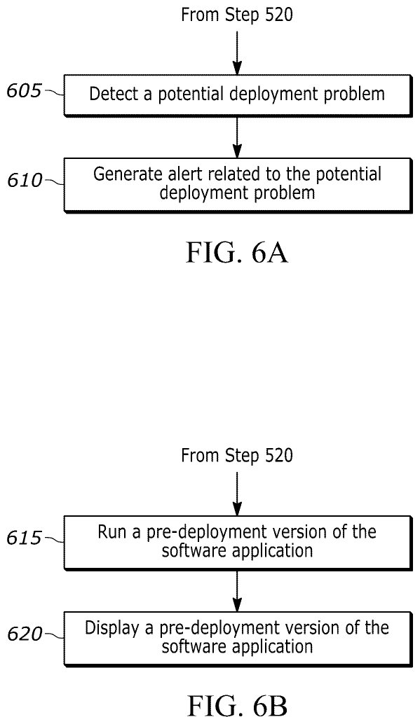

To provide a better understanding of the techniques described herein, FIG. 1 depicts an example computing environment in which techniques of the present disclosure may be implemented, and FIGS. 2-4 depict example message screens that may be displayed during the deployment validation process, in accordance with various embodiments described herein. FIGS. 5, 6A, and 6B depict example process flows, in accordance with various embodiments described herein.

FIG. 1 depicts an example computing system 100 in which various embodiments of the present disclosure may be implemented. The example computing system 100 may include a computing device 102, a management system 150, user devices 120, 130, and 140, and a network 180. The computing device 102 may be remote from the management system 150 and user devices 120, 130, 140 and may communicate with the management system 150 and user devices 120, 130, 140 via network 180. For example, the computing device 102, the management system 150, and/or the user devices 120, 130, 140 may communicate via USB, Bluetooth, Wi-Fi Direct, Near Field Communication (NFC), etc.

Generally, the computing device 102 may be a device that is associated with (e.g., owned and/or operated by) a particular organization. For instance, a developer of the organization may use the computing device 102 to develop software applications that may be ultimately sent to and/or are otherwise made accessible by the management system 150 through the network 180, i.e., for validation and eventual distribution to the user devices 120, 130, 140, etc. In certain embodiments, the computing device 102 may be a smartphone, a tablet, a laptop, or any other suitable device or combination of devices. The computing device 102 may include various components, such as one or more processors 104, one or more memories 106 that may store data relating to applications 108, communication interfaces 110, displays or screens 112 for displaying information to users, and/or input/output devices 114 for communicating with other devices.

Memories 106 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. Memorie(s) 106 may store an operating system (OS) (e.g., iOS, Microsoft Windows, Linux, UNIX, etc.) capable of facilitating the functionalities, apps, methods, or other software as discussed herein. Memorie(s) 106 may also store one or more applications 108 that may be executed by the one or more processors 104, which may include applications for developing software applications that require validation, applications for sending software applications to a management system 150 for validation, and/or applications for receiving results of the validation from the management system 150. For instance, the results of the validation may include alerts about potential deployment problems present in a software application sent to the management system 150 that may prevent validation, indications regarding potential solutions to any deployment problems present in a software application, notifications about the validation of software applications by the management system 150, notifications about the deployment of the software applications to user devices 120, 130, 140, etc. Moreover, memorie(s) 106 may store software or device applications 108 that, when executed by the one or more processors 104, cause the one or more processors 104 to control the display 112 (e.g., to display the results of the validation or any other alerts, notifications, or indications received from the management system 150), input/output devices 114, and communication interfaces 110 for communicating with the management system 150 or network 180.

The management system 150 may be a server or collection of servers (which may include, for instance, one or multiple computing devices that are co-located or distributed), and may include one or more processors 152, one or more memories 154, and/or one or more communication interfaces 166 for communicating with other computing devices, such as the computing device 102, user device 120, user device 130, and/or user device 140, e.g., via the network 180. Generally speaking, the management system 150 may perform analyze software applications received from the computing device 102 for potential deployment problems, and validate (or not validate) the software applications for wider user (e.g., by the user devices 120, 130, 140) based on this analysis.

Memories 154 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. Memorie(s) 106 may store an operating system (OS) (e.g., iOS, Microsoft Windows, Linux, UNIX, etc.) capable of facilitating the functionalities, apps, methods, or other software as discussed herein. Memorie(s) 154 may store one or more applications that may executed by the one or more processors 152, as well as a software application database 156, which may store software applications received by the management system 150 from the computing device 102 (i.e., software applications developed by a user of the computing device 102) that are to be validated. The one or more applications may include a validation application 158 that may analyze the software applications stored in the software application database for validation, as well as, in some examples, a machine learning model 160 which the validation application 158 may use as part of the analysis, and/or a machine learning model training application 162 which may train the machine learning model 160. Memorie(s) 154 may further store information related to validation processes and criteria, such as a listing of potential deployment problems and related information.

The software applications stored in the software application database 156 may include software applications from the computing device 102 that are in the process of validation or have been validated, i.e., applications that have not been deployed or applications that have been deployed. The software application database 156 may further store information associated with the software applications stored in the database 156, including information related to ownership, usage, and data sources for the software application, or other necessary or useful data. The validation application 158 may analyze the software applications from the software application database 156 to identify potential deployment problems, and/or solutions to potential deployment problems, in some cases using the machine learning model 160.

In some examples, a machine learning model 160 may be executed on the management system 150, while in other examples the machine learning model 160 may be executed on another computing system, separate from the management system 150. For instance, the management system 150 may send one or more software applications stored in the software application database 156, and/or data, parameters, or specifications associated therewith, to another computing system, where a trained machine learning model may be applied to the software application and/or the data, parameters, or specifications associated therewith, and the other computing system may determine, predict, or identify any potential deployment problems, based upon applying the trained machine learning model 160 to the software application and/or the data, parameters, or specifications associated therewith. The other computing system may then send any determined, predicted, or identified potential deployment problems to the management system 150. Moreover, in some examples, the machine learning model 160 may be trained by a machine learning model training application 162 executing on the management system 150, while in other examples, the machine learning model 160 may be trained by a machine learning model training application executing on another computing system, separate from the management system 150.

Whether the machine learning model 160 is trained on the management system 150 or elsewhere, the machine learning model 160 may be trained by the machine learning model training application 162 using training data corresponding to historical user data. Historical user data may include historical software applications or data associated therewith, and historical deployment problems associated with the historical software applications. The trained machine learning model 160 may then be applied to user data in order to predict or identify potential deployment problems, which the validation application 158 may use to validate the application.

In some embodiments, the machine learning models described herein employ supervised learning, which involves identifying patterns in existing data to make predictions about subsequently received data. Specifically, the machine learning models may be “trained” using training data, which includes example inputs and associated example outputs. The example inputs and example outputs of the training data may include any of the data inputs or machine learning outputs described above, such as information associated with historical software applications, and/or deployment problems associated therewith. Based upon the training data, the machine learning models may generate a predictive function which maps outputs to inputs and utilize the predictive function to generate machine learning outputs based upon data inputs. In the exemplary embodiment, a processor 152 may be trained by providing the machine learning model with a large sample of data with known characteristics or features.

In various aspects, the machine learning model 160 may comprise a machine learning program or algorithm that may be trained by and/or employ a neural network, which may be a deep learning neural network, or a combined learning module or program that learns in one or more features or feature datasets in particular area(s) of interest. The machine learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine learning algorithms and/or techniques. The machine learning model 160 may be or may include a multimodal (e.g., text, audio, video, image, etc.) language model, and may be a small language model, a large language model, and/or a hybrid language model in various embodiments for purposes of model efficiency and/or specificity.

In some embodiments, the machine learning training application 162 used to train the machine learning model 160 may comprise a library or package executed on the management system 150 (or other computing devices not shown in FIG. 1). For example, such libraries may include the TENSORFLOW based library, the PYTORCH library, and/or the SCIKIT-LEARN Python library.

In some embodiments, at least one of a plurality of machine learning methods and algorithms are applied, which may include but are not limited to: cluster analysis, k-nearest neighbor algorithms, and/or other machine learning programs/algorithms either individually or in combination. In various embodiments, the implemented machine learning methods and algorithms are directed toward at least one of a plurality of categorizations of machine learning, such as unsupervised learning.

It is to be understood that supervised machine learning and/or unsupervised machine learning may also comprise retraining, relearning, or otherwise updating models with new, or different, information, which may include information received, ingested, generated, or otherwise used over time. Further, it should be appreciated that, as previously mentioned, the machine learning model described herein may be used to output clusters of event sequences and timing features, sub-clusters of the event sequences and timing features, data objects, and/or any other values, responses, or combinations thereof using artificial intelligence or, in alternative aspects, without using artificial intelligence.

Once a software application has been validated, communication interface 166 may send the application over the network 180 to the user devices 120, 130, and 140 for use by a wider user group. The communication interface 166 may enable the management system 150 to communicate with the computing device 102, user devices 120, 130, 140, and/or any other suitable devices or combinations thereof. More specifically, the communication interface 166 enables the management system 150 to communicate with each component of the example computing device 102 and user devices 120, 130, 140 across the network 180 through their respective communication interfaces 110, 124, 134, 144. The communication interfaces 110, 124, 134, 144 may support wired or wireless communications, such as USB, Bluetooth, Wi-Fi Direct, Near Field Communication (NFC), etc. The communication interface 166 may enable the management system 150 to communicate with the various components of the example computing device 102 and user devices 120, 130, 140 via a wireless communication network such as a fifth-, fourth-, or third-generation cellular network (5G, 4G, or 3G, respectively), a Wi-Fi network (802.11 standards), a WiMAX network, or any other suitable wide area network (WAN), local area network (LAN), or personal area network (PAN), etc.

User device 120 may include a processor 121, one or more memories 122 that store one or more applications 123, communication interfaces 124, display or screens 125, and input/output devices 126. Similarly, user device 130 may include a processor 131, one or more memories 132 that store one or more applications 133, communication interfaces 134, display or screens 135, and input/output devices 136. Additionally, user device 140 may include a processor 141, one or more memories 142 that store one or more applications 143, communication interfaces 144, display or screens 145, and input/output devices 146. The communication interfaces of each device 124, 134, 144 may include any suitable communication protocol, such as Wi-Fi, wide area networks, local area networks, Bluetooth, IEEE 802.11, LTE/5G, or the like. Applications 123, 133, 143 may include software applications that have been developed in-house and deployed or device applications used for operating the device, such as applications that control a display 125, 135, 145, input/output device 126, 136, 146, or communications interface 124, 134, 144.

The user devices 120, 130, 140 may receive a deployed software application from the management system 150 once it has been validated for deployment. It should be understood that not all user devices will receive all deployed software applications. A software application may be sent only to those user devices allowed to use the application, such as sending a software application related to accounting processes to users in an accounting group. Users working in other organizational areas, such as operations or training, may not need software applications related to accounting, but may have their own developed, validated, and deployed software applications.

Each of the processors 104, 121, 131, 141, 152 may include any suitable number of processors and/or processor types. For example, the processors 104, 121, 131, 141, 152 may each include one or more CPUs and one or more graphics processing units (GPUs). Generally, each of the processors 104, 121, 131, 141, 152 may be configured to execute software instructions stored in each of the corresponding memories 106, 122, 132, 142, 154. The memories 106, 122, 132, 142, 154 may each include one or more persistent memories (e.g., a hard drive and/or solid-state memory) and may store one or more applications, modules, and/or models, such as software applications validated by the validation application 158 of the management system 150.

Moreover, the network 180 may be a single communication network, or may include multiple communication networks of one or more types (e.g., one or more wired and/or PANs or LANs, and/or one or more WANs such as the Internet). In some embodiments, the network 180 includes multiple, entirely distinct networks (e.g., one or more networks for communications) between management system 150 and computing devices 102, and a separate, Bluetooth or wireless LAN (WLAN) network for communications between management system 150 and user device 120, and so on).

FIG. 2 depicts an example message screen 200 that may be displayed on a display screen 112 by the input/output device(s) 114 of the computing device 102 as a home page to the user as part of the validation process. The top right of the display shows the user picture or other image and name 201 and indicates that the user has been signed in and registered with the system. The left side of the display may offer several useful shortcut links 202, such as “Home,” “Pre-Deployment,” “My Deployments,” “How to Use” the validation system, “Support,” and “Settings.” The “Home” link takes the user to the home page, the “Pre-Deployment” link takes users to a list of software applications that are in the pre-deployment phase, the “My Deployments” link takes a user to a list of all of the software applications that are both deployed and in the pre-deployment stage. The “Support” link that shows a list of support available to users, and a “Settings” link that allows users to change settings associated with their account. Of course, other links that may be deemed useful may be placed in this area of the screen.

The main area of the screen includes several sections that are used by the user as part of the validation process. There may be an “Upload a Solution” section that includes a link 202 that allows a user to upload a software application to a management system, such as management system 150. There may also be a listing of all the software applications that the user is associated with in the “My Solutions” section 206. These may both be software applications that have been deployed and those that are in the validation process. At the bottom of this section may be a link to “View Pre-Deployments” that allows the user to see a non-validated version of a software application. There may also be a section for helpful information, such as an explanation of “What is the ALM app?” which explains the purpose of the validation process. This section may also include links to view a users'deployments, review runbooks, or deploy solutions that have been validated. A runbook may be a repository of information associated with a particular software application, such as the folder path, service account information, and other associated information. At the bottom of the screen may be a “Frequency Asked Questions” section 210 that includes information related to common questions that users face as part of the validation process.

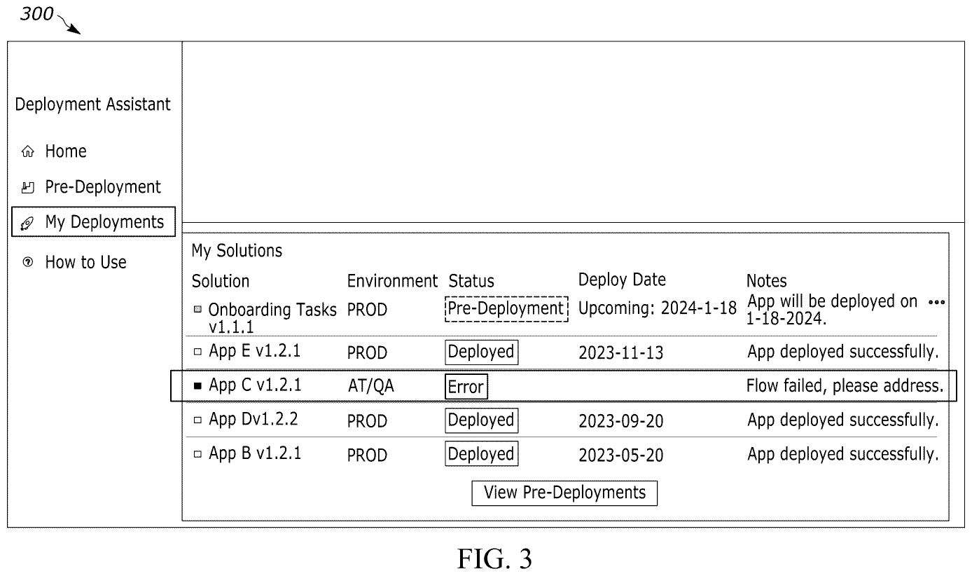

FIG. 3 shows an example screen that may be displayed on the computing device 102 when a user follows the “My Deployments” link 202 from FIG. 2. Under the “My Solutions” heading may be a list of software applications, also called “solutions,” that have been developed and uploaded to the management system. The information included for each may be the name of the solution, the environment it is developed for and built in, the status, deployment date, and any relevant notes. As shown in FIG. 3, the status of the top listing may be set to “Pre-Deployment” indicating that has not been fully deployed yet, but the deployment date is listed as “Upcoming” with a date specified. This information may be also listed in the “Notes” section. The status of the third software application down is listed as “Error,” which indicates that the validation process is unable to proceed due to the software application not meeting the validation criteria. Additionally, the notes section states that the validation process flow has failed and must be addressed by the user.

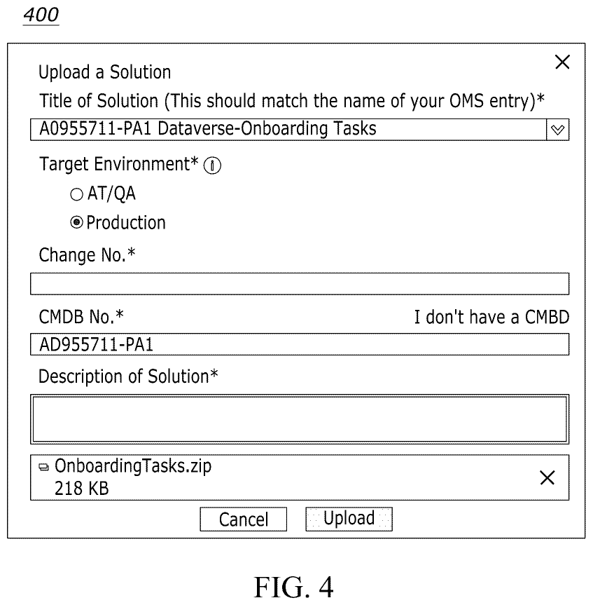

FIG. 4 shows an example screen that may be generated when the “Upload a Solution” link 204 is selected by a user. The display 112 of computing device 102 displays an “Upload a Solution” screen that includes an area to enter a title of the solution, the target environment, e.g. (AT/QA or Production), and other tracking information, such as a change number or configuration management database (CMDB) number. The user also enters a description of the solution or software application, e.g., what problem it is addressing or how it will streamline software operations.

FIG. 5 depicts an example validation workflow, which may be performed by the one or more processors 152 in the management system, executing instructions stored on one or more memories 154. The method begins at block 505 where the system may receive data input from a user that corresponds to a software application. The input data may be received at the management system 150 through network 180 from computing device 102. In block 510, the software application may be stored in a management system, such as a software application database 156 that stores information related to ownership, usage, and data sources for the software application.

In block 515, the management system 150 performs validation of the software application that the software application meets a criteria using validation application 158, where the validation involves analyzing the software application for potential deployment problems and may include using machine learning model 160 as part of the analysis. The criteria may include at least analyzing if the software application is related to an authorized user or group. Analyzing a software application may include comparing it to a specified set of criteria that has been developed to meet the requirements or needs of an organization. Other validation criteria may include ensuring that the software application is associated with a valid service account, that the software application is properly named, or that the software application is shared with a specified service group. The service group may include any users that are able to maintain the software application or are involved in its development. A valid service account may be an account that is managed or maintained by the organization. This ensures that developers from outside an organization are not able to deploy software applications and that if a developer leaves an organization, the software application is still associated with an organization account. An invalid service account may be any account that is not associated with an organization, such as a personal email account, code repository, e.g., GitHub, or similar. A proper name for the software application, for example, may include words or codes that indicate what part of an organization it is directed to, who developed the software application, a version number, or any appropriate naming convention. An improper name may not meet organization-defined criteria, such as those listed above or any naming convention defined by the organization.

In block 520, the system determines if the validation criteria are met. If the criteria are not met, then the system may restrict the software application from deployment and wider use at block 525. If the criteria are met, then the software application may be deployed for wider use in an organization at block 530. For example, if the validation criteria are not met, application management system 150 may block the software application from being distributed through network 180. This may be accomplished, for example, by changing a permission level associated with the software application that restricts who may access it. An unvalidated software application may only allow users from specified user groups access, such as the user or group that originally developed the software application or an organizations' dedicated software development and support group. Alternatively, if the software application is validated by meeting the validation criteria, the management system 150 may allow the software application to be accessed by other computing devices, such as user devices 120, 130, and 140, such as by changing the permission level associated with the software application to allow unrestricted access to the software application. As another option, when a software application is validated, it may be included in a list of available software applications for user devices 120, 130, and 140 to download or run remotely. It should be noted that criteria may change over time, so a software application that meets the validation criteria at one point in time may not meet the validation criteria at a later point in time.

In addition, the validation process as performed by processor 152 in the management system may include verifying that the user is registered in a user management system, such as management system 150, and responding to the data input from the user based on the result of the verification. For example, if a user that is not registered in the user management system 150 and attempts to start the validation process, a prompt may be displayed to the user that prompts them to register in the management system. Alternatively, the user may be prevented from beginning the validation process until they have been registered in the user management system 150. The user management system database 156 may be the same as the configuration management database or any suitable data repository.

When a software application is deployed, that deployment may be scheduled in the management system 150 for a certain date or time, which may be chosen for several reasons, such as availability of the user group to support the software application, ease of deployment, availability of the data that the software application uses for operation, or the like. If a software application has been fully validated, the deployment may be scheduled by a user or automatically by the system. Either way, the deployment is subject to constraints related to how soon the software application may be deployed. For example, the software application may not be immediately deployed to allow for operational support to prepare for the deployment. Concomitantly, the deployment may be canceled in the management system 150 by a request of the user. This may occur if the user has new information, the goals of the software application have changed, or the software application is no longer needed. A software application deployment may be scheduled or cancelled by a user or the system 100, such as the management system 150 or manually using the computing device 102.

In addition, once the validation process is complete, unauthorized users or groups may be prevented from deploying the software application by the management system 150. The unauthorized users or groups may include the user or group that uploaded the software application for validation. This prevents the software application from being deployed before the greater organization is prepared for it or before it is needed and limits deployment decisions to a select group in an organization that monitors the operation of any software application to ensure proper functioning.

If the software application does not meet the validation criteria and is restricted, the software application may not be deployed to a wider user group than the authorized user or group that is associated with the software application as part of the validation process. Further, restricting a software application may also include restricting it from running on another device of a user that may be outside the authorized user group.

During block 515, if the software application does not meet the validation criteria, the system may cause prompts to display on the user input/output device(s) 114 to inform the user that validation is not complete, along with the criteria that the software application still needs to meet to complete the validation process. By displaying the prompts, the system may guide the user towards known solutions that will remove deployment problems and reduce the effort required to validate a software application and streamline the deployment process. For example, a prompt may be displayed that states “Missing or incorrect application name.” A following prompt may then be displayed that provides actions to correct the application name, e.g., the name must relate to the purpose or function of the software application or include the business unit that the application is developed for.

In some embodiments, a machine learning (machine learning) algorithm may be employed as part of the validation process to analyze software applications for potential deployment problems. machine learning algorithms may be implemented into block 515 of FIG. 5. The machine learning algorithm may be trained in the management system 150 by training application 162 using labeled training data that is indicative of past user-generated information or system-generated information associated with past software applications, and any deployment problems associated with the past software applications. A display or screen 112 may show the results of the machine learning algorithm analysis as a list of potential deployment problems. Further, the validation application 158 may apply options or alternatives identified by the machine learning model 160 to the detected potential deployment problems to remove the potential problem. For example, if the machine learning model 160 algorithm detected a potential deployment problem, such as the lack of a valid service account associated with the software application, the validation application 158 could automatically assign a service account from a list of available accounts based on previous software applications, a predefined list, or use a generic service account that is accessible by a support team. Alternatively, the machine learning model 160 could identify a potential service account based on similar software applications that are associated with valid service accounts. Additionally, the machine learning model 160 may output a list of any remedies to potential deployment problems that may be automatically applied to the software application as part of the validation process.

In certain embodiments, the machine learning model(s) utilized as part of block 515 is or includes an unsupervised decision tree configured/trained to analyze software applications. In certain embodiments, the machine learning models described herein employ unsupervised learning, which involves finding meaningful relationships in unorganized data. Unlike supervised learning, unsupervised learning does not involve user-initiated training based upon example inputs with associated outputs/labels. Rather, in unsupervised learning, the machine learning model organizes unlabeled data according to a relationship determined by at least one machine learning method/algorithm employed by the machine learning model. Unorganized data may include any combination of data inputs and/or machine learning outputs, as described above.

FIGS. 6A and 6B depict further steps that may be executed by the system 100 as part of the validation process. In FIG. 6A, when a potential deployment problem is detected in block 605 following block 520 of FIG. 5, the management system 150 may generate an alert that may be displayed on the display 112 of computing device 102. This alert may be used as a method for alerting the user that a potential problem exists that should be examined and potentially remediated. The alerts may be sent to the associated user using a pop-up on a display, by email, text message, instant message, or other appropriate means. Additionally, the alerts may indicate options and/or actions that the user may apply to remove the potential deployment problem. This allows the user to adjust the software application as problems are detected rather than having to address a long list of problems at once.

During the validation process, it may be helpful for a user to view a pre-deployment version of the software application to see how a portion of the software application runs or appears without having to fully complete the validation process. In FIG. 6B, subsequent to block 520 of FIG. 5, a pre-deployment version of the software application may be run using processor 152 of the management system 150 in block 615 and then displayed on a display or screen 112 of computing device 102 in block 620. A pre-deployment version of a software application is a version of the software application that has not been fully validated and may contain potential deployment problems.

Running a pre-deployment version of a software application allows the developer to correct potential problems one by one as they are caught rather than facing a long list of potential problems all at once. This may also make the development process more approachable to non-technical developers. The pre-deployment version of the software application may be restricted to running on a single device, such as computing device 102. In practice, this may be the computer that the developer is signed into and working on or could be an assigned computing device solely used by the developer. This restricts the pre-deployment version to be accessible to only a single user rather than the software application being pushed to many devices.

It will be understood that the above disclosure is one example and does not necessarily describe every possible embodiment. As such, it will be further understood that alternate embodiments may include fewer, alternate, and/or additional steps or elements.

### EXAMPLES

Example 1. A computer-implemented method for validating a software application, comprising: receiving, by one or more processors, data input from a user that corresponds to a software application; storing, by the one or more processors, the software application in a management system; performing, by the one or more processors, validation of the software application that the software application meets a criteria, wherein validation includes analyzing the software application for potential deployment problems; wherein at least one of the validation criteria may be whether the software application is related to an authorized user or group; and as a result of the validation, either deploying, by the one or more processors, the software application for use outside of the authorized user or group or restricting software application use to the authorized user or group until the validation process is completed.

Example 2. The computer-implemented method of example 1, wherein restricting the software application comprises restricting which users of a wider user group that is larger than the authorized user group are able to access the software application, wherein restricting access includes restricting the software application from running on another device of a user that is outside of an authorized user group.

Example 3. The computer-implemented method of example 1, further comprising displaying, by the one or more processors, prompts on a user interface relating to validation steps that need to be performed to meet the validation criteria.

Example 4. The computer-implemented method of example 3, wherein the validation steps comprise sharing the software application with a specified user group, ensuring that the software application is associated with a valid service account and recorded in a management system, or ensuring that the software application is properly named.

Example 5. The computer-implemented method of example 1, wherein the method further comprises scheduling or canceling, by the one or more processors, the software application deployment in response to a request by a user.

Example 6. The computer-implemented method of example 1, wherein, the method further comprises prevent, by the one or more processors, unauthorized users or groups from deploying a software application.

Example 7. The computer-implemented method of example 1, wherein validation further comprises: running, by the one or more processors, a pre-deployment version of the software application; displaying, by the one or more processors, on a user interface, a pre-deployment version of the software application.

Example 8. The computer-implemented method of example 1, further comprising generating, by the one or more processors, a list of software applications that have been deployed or are in the process of being deployed by a user.

Example 9. The computer-implemented method of example 1, further comprising: detecting, by the one or more processors, a potential deployment problem; generating, by the one or more processors, when a potential deployment problem is detected, an alert indicating the potential deployment problem and options that can remove the deployment problem.

Example 10. The computer-implemented method of example 1, wherein the management system includes a software application database for storing one or more of ownership, usage, and data sources for software applications, and applications that have been deployed or are in the process of deployment.

Example 11. The computer-implemented method of example 1, further comprising: verifying, by the one or more processors, that the user is registered in a user management system; responding, by the one or more processors, to the data input from the user based on the result of the verification.

Example 12. The computer-implemented method of example 1, further comprising: training by one or more processors and using labeled training data, one or more ma-chine learning algorithms to analyze software applications for potential deployment problems based upon at least one of user-generated information or system-generated information associated with the software applications, wherein the labeled training data includes data indicative of past user-generated information or system-generated information associated with past software applications, and any deployment problems associated with the past software applications; and outputting, to a display, a list of potential deployment problems.

Example 13. The computer-implemented method of example 11, wherein when the machine learning algorithm detects a potential deployment problem, the machine learning algorithm applies identified options or alternatives to remove the potential deployment problem.

Example 14. A computing system for deploying an application, comprising: One or more processors; a non-transitory computer-readable medium coupled to the one or more processors and a communication unit and storing instructions thereon that, when executed by the one or more processors, cause the computing device to: receive data input from a user that corresponds to a software application; store the application in a management system; perform validation of the software application that the software application meets a criteria, wherein validation involves analyzing the software application for potential deployment problems, wherein at least one of the validation criteria whether the software application is related to an authorized user or group; and as a result of the validation, either deploy the software application for use outside of the authorized user or group or restrict software application use to the authorized user or group until the validation process is completed.

Example 15. The computing device of example 13, wherein restricting the software application comprises restricting which users of a wider user group that is larger than the authorized user group are able to access the software application, wherein restricting access includes restricting the software application from running on another device of a user that is outside of an authorized user group.

Example 16. The computing device of example 13, wherein a user interface of the computing system displays prompts relating to validation steps that need to be performed to meet the validation criteria.

Example 17. The computing device of example 15, wherein the validation steps comprise sharing the software application with a specified user group, ensuring that the software application is associated with a valid service account and recorded in a management system, or ensuring that the software application is properly named.

Example 18. The computing device of example 13, wherein the software application deployment further comprises scheduling or canceling in response to a request by a user.

Example 19. The computing device of example 13, wherein the one or more processors prevent unauthorized users or groups from deploying a software application.

Example 20. The computing device of example 13, wherein validation further comprises: running, a pre-deployment version of the software application; displaying, on a user interface, a pre-deployment version of the software application.

Example 21. The computing device of example 13, further comprising generating a list of software applications that have been deployed or are in the process of being deployed by a user.

Example 22. The computing device of example 13, further comprising: detecting, by the one or more processors, a potential deployment problem; generating, by the one or more processors, when a potential deployment problem is detected, an alert indicating the potential deployment problem and options that can remove it.

Example 23. The computing device of example 13, wherein the management system is a software application database for storing one or more of ownership, usage, and data sources for software applications and applications that have been deployed or are in the process of deployment.

Example 24. The computing system of example 13, further comprising: verifying, by the one or more processors, that the user is registered in a user management system; responding, by the one or more processors, to the data input from the user based on the result of the verification.

Example 25. A tangible, non-transitory computer-readable medium storing instructions for validating a software application, when executed by one or more processors of a computing device, cause the computing device to: receive data input from a user in the form of code that corresponds to a software application; store the software application in a management system; perform validation of the software application that the software application meets a criteria, wherein validation involves analyzing the software application for potential deployment problems, wherein at least one of the validation criteria is whether the software application is related to an authorized user or group; and as a result of the validation, either deploying the software application for use outside of the authorized user or group or restricting the software application use to the authorized user or group until the validation process is completed.

### ADDITIONAL CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality, and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A computer-implemented method for validating a software application, comprising:
receiving, by one or more processors, data input from a user that corresponds to a software application;
storing, by the one or more processors, the software application in a management system;
performing, by the one or more processors, a validation process of the software application that the software application meets a criteria, wherein validation includes analyzing the software application for potential deployment problems; wherein at least one of the criteria is whether the software application is related to an authorized user or group; and
as a result of the validation, either deploying, by the one or more processors, the software application for use outside of the authorized user or group or restricting software application use to the authorized user or group until the validation process is completed.

2. The computer-implemented method of claim 1, wherein restricting the software application comprises restricting which users of a wider user group that is larger than an authorized user group are able to access the software application, wherein restricting access includes restricting the software application from running on another device of a user that is outside of an authorized user group.

3. The computer-implemented method of claim 1, further comprising displaying, by the one or more processors, prompts on a user interface relating to validation steps that need to be performed to meet the criteria.

4. The computer-implemented method of claim 3, wherein the validation steps comprise sharing the software application with a specified user group, ensuring that the software application is associated with a valid service account and recorded in a management system, or ensuring that the software application is properly named.

5. The computer-implemented method of claim 1, wherein the computer-implemented method further comprises scheduling or canceling, by the one or more processors, a deployment of the software application in response to a request by a user.

6. The computer-implemented method of claim 1, wherein the computer-implemented method further comprises preventing, by the one or more processors, unauthorized users or groups from deploying a software application.

7. The computer-implemented method of claim 1, wherein validation further comprises:
running, by the one or more processors, a pre-deployment version of the software application; and
displaying, by the one or more processors and on a user interface, a pre-deployment version of the software application.

8. The computer-implemented method of claim 1, further comprising generating, by the one or more processors, a list of software applications that have been deployed or are in process of being deployed by a user.

9. The computer-implemented method of claim 1, further comprising:
detecting, by the one or more processors, a potential deployment problem; and
generating, by the one or more processors, when a potential deployment problem is detected, an alert indicating the potential deployment problem and options that can remove the potential deployment problem.

10. The computer-implemented method of claim 1, wherein the management system includes a software application database for storing one or more of ownership, usage, and data sources for software applications, and applications that have been deployed or are in process of deployment.

11. The computer-implemented method of claim 1, further comprising:
verifying, by the one or more processors, that the user is registered in a user management system; and
responding, by the one or more processors, to the data input from the user based on the result of the validation.

12. The computer-implemented method of claim 1, further comprising:
training by one or more processors and using labeled training data, one or more machine learning algorithms to analyze software applications for potential deployment problems based upon at least one of user-generated information or system-generated information associated with the software applications, wherein the labeled training data includes data indicative of past user-generated information or system-generated information associated with past software applications, and any deployment problems associated with the past software applications; and
outputting, to a display, a list of potential deployment problems.

13. The computer-implemented method of claim 12, further comprising:
detecting, by the one or more processors and using the one or more machine learning algorithms, a potential deployment problem;
identifying, by the one or more processors and using the one or more machine learning algorithms one or more options or alternatives to remove the potential deployment problem; and
applying, by the one or more processors, identified options or alternatives to remove the potential deployment problem.

14. A computing system for deploying an application, comprising:
one or more processors;
a non-transitory computer-readable medium coupled to the one or more processors and a communication unit and storing instructions thereon that, when executed by the one or more processors, cause the computing system to:
receive data input from a user that corresponds to a software application;
store the application in a management system;
perform a validation process of the software application that the software application meets a criteria, wherein validation involves analyzing the software application for potential deployment problems, wherein at least one of the criteria whether the software application is related to an authorized user or group; and
as a result of the validation, either deploy the software application for use outside of the authorized user or group or restrict software application use to the authorized user or group until the validation process is completed.

15. The computing system of claim 14, wherein restricting the software application comprises restricting which users of a wider user group that is larger than an authorized user group are able to access the software application, wherein restricting access includes restricting the software application from running on another device of a user that is outside of an authorized user group.

16. The computing system of claim 14, wherein a user interface of the computing system displays prompts relating to validation steps that need to be performed to meet the criteria.

17. The computing system of claim 16, wherein the validation steps include one or more of: sharing the software application with a specified user group, ensuring that the software application is associated with a valid service account and recorded in a management system, or ensuring that the software application is properly named.

18. The computing system of claim 14, wherein validation further comprises:
running a pre-deployment version of the software application; and
displaying, on a user interface, a pre-deployment version of the software application.

19. The computing system of claim 14, further comprising:
detecting, by the one or more processors, a potential deployment problem; and
generating, by the one or more processors, when a potential deployment problem is detected, an alert indicating the potential deployment problem and options that can remove it.

20. A tangible, non-transitory computer-readable medium storing instructions for validating a software application, when executed by one or more processors of a computing device, cause the computing device to:
receive data input from a user that corresponds to a software application;
store the software application in a management system;
perform a validation process of the software application that the software application meets a criteria, wherein validation involves analyzing the software application for potential deployment problems, wherein at least one of the criteria is whether the software application is related to an authorized user or group; and
as a result of the validation, either deploy the software application for use outside of the authorized user or group or restrict use of the software application to the authorized user or group until the validation process is completed.
